(19) United States
(12) Patent Application Publication
(10) Pub. No.: US 2005/0020325 A1
(43) Pub. Date: Jan. 27, 2005

(54) Multi-configuration portable electronic device and method for operating the same

(75) Inventors: Todd M. Enger, Chicago, IL (US); Shimon Goldstein, Coral Springs, FL (US); James L. Tracy, Coral Springs, FL (US); Hung Q. Vuong, Margate, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/626,239

(22) Filed: Jul. 24, 2003

(51) Int. Cl. H04M 1/00

(52) U.S. Cl. 455/575.3

(57) ABSTRACT

A multi-configuration portable electronic device is provided. The device includes at least one processor, a first body element including at least one input, and a second body element including a display. The second body element is pivotally coupled to the first body element such that the device can be positioned into a plurality of physical configurations. In response to a change in the physical configuration of the device, there is a change in at least two of a mode of operation of the input device, a mode of operation of the display, and an active software application being executed by the processor. In a preferred embodiment, the physical configurations of the device include a portrait configuration in which the device functions as a wireless phone, and a landscape configuration in which the device functions as a text messaging pager, PDA, handheld computer, electronic organizer, or media player. Also provided is a method of operating a portable electronic device having a plurality of physical configurations.

### FIELD OF THE INVENTION

The present invention generally relates to the field of portable electronic devices, and more particularly to portable electronic devices that are adaptable to multiple functional configurations.

### BACKGROUND OF THE INVENTION

Electronic devices, particularly portable electronic devices, are widely used for business and personal activities, and are continually increasing in popularity. Portable electronic devices (interchangeably referred to herein as “portable devices” and “devices”) include, for example, cellular (or wireless) phones and other voice communication devices (e.g., two-way radios), personal digital assistants (“PDAs”) and electronic organizers, pagers and text messaging devices, handheld computers (including “palmtop” and “tablet” computers) and internet browsers, navigation devices and satellite communication devices such as global positioning systems (“GPSs”), cameras, video game devices, media players (e.g., music players and video players), portable medical devices, data collection devices such as environmental monitoring systems, and so on.

Users continually desire increased functionality from portable electronic devices. Moreover, because of the large assortment of portable devices that are available, and the wide variety of functions that these portable devices are each able to perform individually, it would be desirable to integrate the capabilities and functionality of different devices into a single portable device, so as to eliminate the need to carry multiple devices. From a user's perspective, eliminating the need to carry multiple devices is a significant advantage because carrying multiple devices is cumbersome and increases the likelihood that one or more devices will be lost or damaged. Additional advantages that can be realized by integrating the capabilities of multiple devices into a single device include eliminating the need to purchase multiple devices, as well as eliminating the need to purchase and maintain separate batteries and accessories for each separate device.

However, integration of multiple device capabilities into a single device is hindered by the need to provide an ergonomic user interface that is effective for multiple different modes of operation. For example, cellular phones typically have a standardized numeric keypad. On the other hand, text messaging pagers, PDAs, hand-held computers, and other devices on which a user commonly enters text, typically have a “QWERTY” (or “text”) keypad similar to the conventional keyboard layouts of computers and typewriters. Furthermore, the physical layout generally differs between different keypad configurations, making integration more difficult. For example, QWERTY keypads are generally wider than standardized numeric keypads.

In addition to the aforementioned problems associated with the user interface, integration of multiple devices into a single device is made more problematic because different types of devices typically require different displays for optimal presentation of information, depending on the intended purpose. For example, a small display is usually sufficient for cellular phones, which typically display only a limited number of alphanumeric characters, such as names and telephone numbers. On the other hand, text messaging pagers, PDAs, hand-held computers, and other devices that display lengthier text and/or graphics generally benefit from having a wider display.

Although multi-functional electronic devices are desirable, users also favor portable devices that are compact and lightweight. Thus, major challenges are confronted in the competing design objectives of integrating multi-functional capabilities into a single device, while also minimizing the size and weight of the device.

Therefore a need exists to overcome the problems with the prior art as discussed above.

### SUMMARY OF THE INVENTION

Briefly, in accordance with one aspect of the present invention, there is provided a multi-configuration portable electronic device that includes at least one processor, a first body element including at least one input, and a second body element including a display. The second body element is pivotally coupled to the first body element such that the device can be positioned into a plurality of physical configurations. In response to a change in the physical configuration of the device, there is a change in at least two of a mode of operation of the input device, a mode of operation of the display, and an active software application being executed by the processor. In one preferred embodiment, the physical configurations of the device include a portrait configuration in which the device functions as a wireless phone and a camera, and a landscape configuration in which the device functions as a text messaging pager, PDA, handheld computer, electronic organizer, or media player.

In accordance with another aspect of the present invention, there is provided a method of operating a portable electronic device having a plurality of physical configurations. According to the method, an interrupt is generated in response to a change in the physical configuration of the device. In response to the interrupt, there is changed at least two of a mode of operation of an input (e.g., a keypad or mouse) of the device, a mode of operation of a display of the device, and an active software application being executed on the device.

### BRIEF DESCRIPTION OF THE DRAWINGS

FIG. 1 shows an isometric view of a multi-configuration portable electronic device in the portrait configuration in accordance with a preferred embodiment of the present invention.

FIG. 2 shows an isometric view of a multi-configuration portable electronic device in the landscape configuration in accordance with a preferred embodiment of the present invention.

FIG. 3 shows an isometric view of the underside of a circuit board and a flip cover of a multi-configuration portable electronic device in the portrait configuration in accordance with a preferred embodiment of the present invention.

FIG. 4 shows an isometric view of the underside of a circuit board and a flip cover of a multi-configuration portable electronic device in the landscape configuration in accordance with a preferred embodiment of the present invention.

FIG. 5 shows an isometric view of the underside of a circuit board and a flip cover of a multi-configuration portable electronic device in the closed configuration in accordance with a preferred embodiment of the present invention.

FIG. 6 is a flow chart illustrating the process by which alternative modes of operation of a multi-configuration device are actuated based on physical configuration in accordance with a preferred embodiment of the present invention.

### DETAILED DESCRIPTION

The present invention, according to a preferred embodiment, overcomes problems with the prior art by providing a portable electronic device that integrates the functionality of multiple independent devices into a single portable device, while having an ergonomic user interface and display that are effective across different physical configurations and modes of operation, and while further having a relatively small overall size and weight.

In preferred embodiments, the present invention provides a multi-configuration portable electronic device having multiple modes of operation that are actuated by repositioning a body element (such as a flip cover) of the device to multiple alternative configurations (such as portrait, landscape, and closed configurations). Repositioning the body element changes the mode of operation of, for example, inputs, displays, and/or active software applications of the device. For example, the inputs can include an adaptable keypad, and repositioning the body element can cause the characters on the adaptable keypad to change, such as by switching between numeric and “QWERTY” keypad layouts. As another example, repositioning the body element can cause the display to switch between displaying images in either a portrait or landscape display format.

As yet another example, repositioning the body element can cause the active software application to switch, such as between a phone dialer application for a cellular (or wireless) phone and an organizer or text-messaging application for a PDA or text-messaging pager. Preferably, the mode of operation is changed “on the fly” without having to reload the operating system, software applications, drivers, etc., and without the need for a processor to continuously monitor the physical configuration of the device. By switching between configurations, the device can provide the functionality of multiple different types of devices in a single unit. For example, in one embodiment a device functions as a cellular phone (amongst other functions) in a portrait configuration, whereas the device functions as a PDA, handheld computer, or text-messaging pager in a landscape configuration. Thus, in preferred embodiments, the device automatically reconfigures its mode of operation to match its physical configuration.

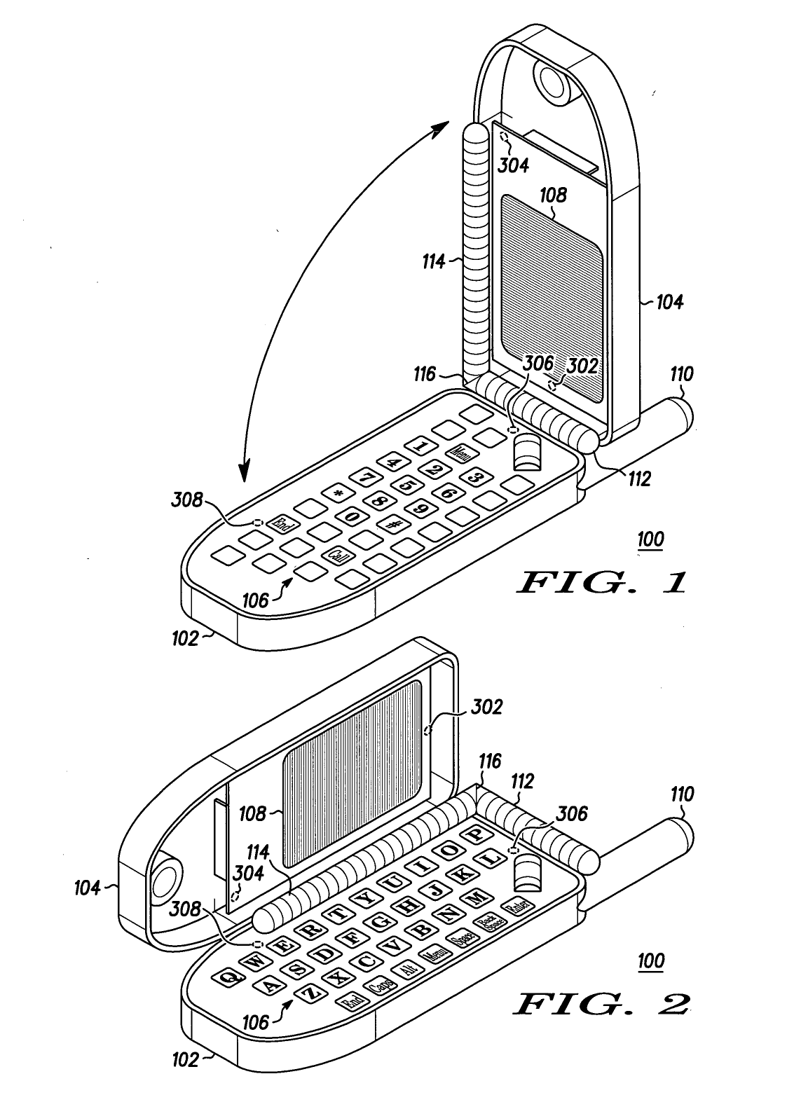

FIGS. 1 and 2 illustrate an exemplary multi-configuration portable electronic device 100 (“device 100”) in accordance with a preferred embodiment of the present invention. FIG. 1 illustrates the device 100 in an exemplary “portrait” configuration, and FIG. 2 illustrates the device 100 in an exemplary “landscape” configuration.

The multi-configuration portable electronic device 100 includes a main body element 102 coupled to a flip cover body element 104. The device 100 also includes inputs 106 and a display 108. In this embodiment, the inputs 106 are disposed on the main body 102, and the display 108 is disposed on the flip cover 104. The inputs 106 include, for example, a keypad (or keyboard), as well as other input devices such as a mouse for navigating a cursor/pointer on the display. FIG. 1 also depicts an antenna 110 for the electronic communication device; an antenna may be absent in some embodiments.

In this embodiment of the present invention, the multi-configuration portable electronic device 100 can assume at least three different physical configurations: a “portrait” configuration (illustrated in FIG. 1), a “landscape” configuration (illustrated in FIG. 2), and a “closed” configuration. In the portrait configuration, the flip cover 104 is opened such that a long dimension of the flip cover 104, which is substantially rectangular in shape, is positioned in a substantially longitudinal position with respect to the main body 102 (as shown in FIG. 1), such as in typical cellular phone configurations. In the landscape configuration, the flip cover 104 is opened such that the long dimension of the flip cover 104 is positioned in a substantially lateral position with respect to the main body 102 (as shown in FIG. 2). The landscape configuration is typically appropriate for text messaging pagers, PDAs, or hand-held computers. To use the device 100 in either the portrait or landscape configuration, a user positions the flip cover 104 in either the portrait or landscape configuration, and thereby actuates the corresponding mode of operation of the device 100. According to this embodiment of the present invention, the user adjusts the physical orientation of the device 100 by rotating the device 100 substantially 90 degrees.

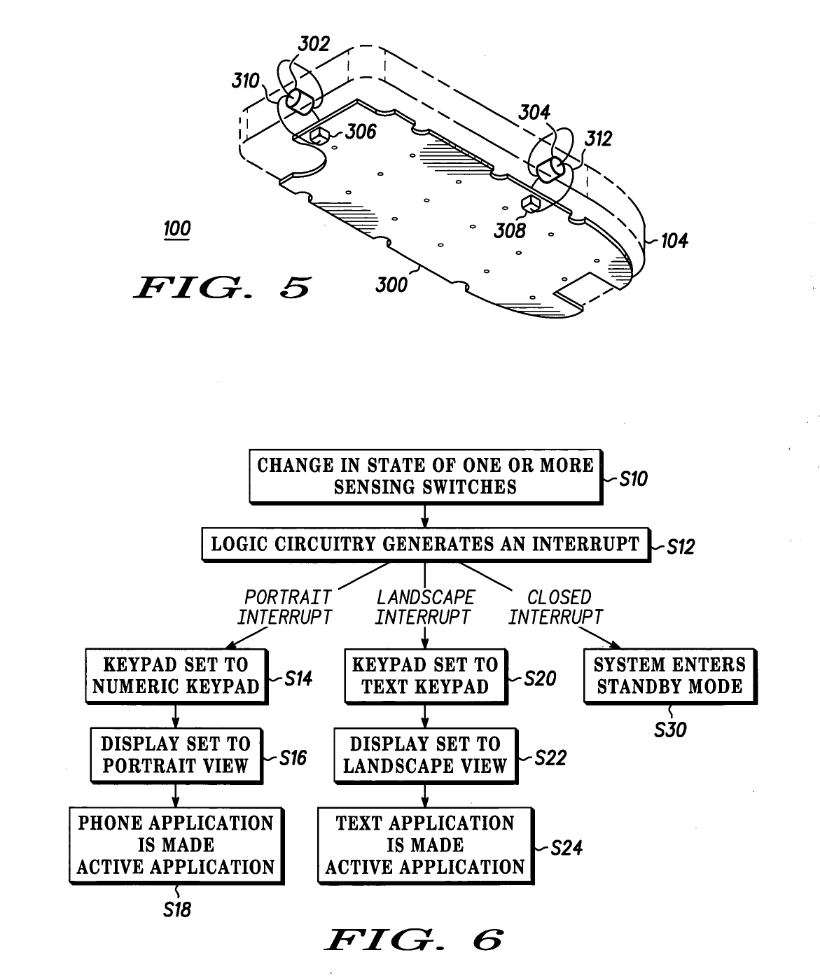

In a “closed” configuration (which is shown in FIG. 5), the flip cover 104 is rotated into contact with the main body 102 such that the flip cover 104 substantially covers the main body 102. Generally, the flip cover 104 is positioned in the closed configuration in order to close and protect the device 100 when not is use, such as during storage or when being carried. In the closed configuration, the device 100 is generally in a standby mode or turned off in order to conserve battery power. In further embodiments, the device does not have a closed configuration and/or has other configurations.

FIGS. 1 and 2 illustrate a portrait hinge 112, a landscape hinge 114, and a joint 116. The portrait hinge 112 enables the flip cover 104 to be rotated/pivoted between the portrait configuration (depicted in FIG. 1) and the closed configuration. The landscape hinge 114 enables the flip cover 104 to be rotated/pivoted between the landscape configuration (depicted in FIG. 2) and the closed configuration. The joint 116 enables the flip cover 104 to be rotated/pivoted between the portrait, landscape, and closed configurations. The hinge and joint assemblies used in this embodiment of the present invention are described in greater detail in U.S. patent application Ser. No. 10/150,244, which is hereby incorporated by reference.

The exemplary inputs 106 shown in FIGS. 1 and 2 include a keypad. In the portrait configuration illustrated in FIG. 1, the keypad functions as a numeric keypad typical of cellular phones. In the landscape configuration illustrated in FIG. 2, the keypad functions as a “QWERTY” (or text) keypad typical of the conventional keyboard layouts of computers and typewriters. In preferred embodiments of the present invention, the keypad layout is changed “on the fly” between such configurations as a numeric keypad and a QWERTY keypad as the flip cover 104 is switched between the portrait configuration and the landscape configuration.

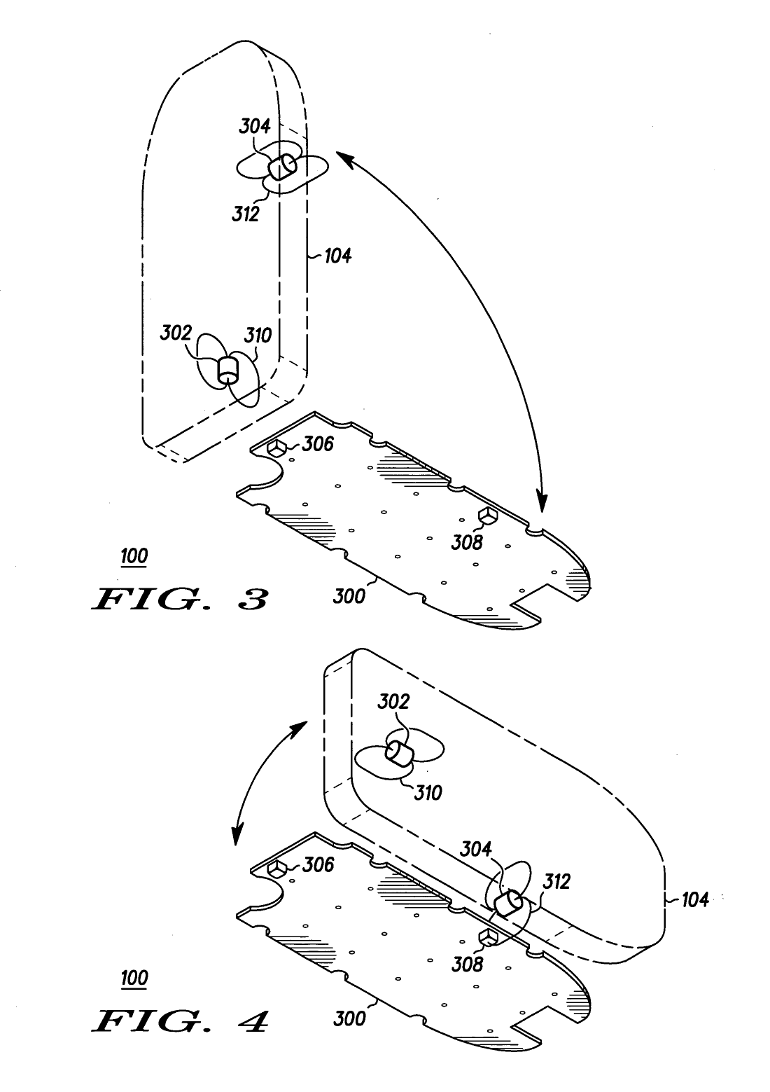

FIGS. 1 and 2 also indicate as dashed lines the positions of various magnets and Hall-effect switches disposed about the device 100 in this embodiment. Specifically, FIGS. 1 and 2 indicate the positions of a portrait magnet 302, landscape magnet 304, portrait Hall-effect switch 306, and landscape Hall-effect switch 308 (all of which are shown in greater detail in FIGS. 3 through 5). In the exemplary embodiment shown in FIGS. 1 and 2, the Hall-effect switches are disposed in the main body 102 (e.g., on one or more circuit boards) and the magnets are disposed in the flip cover 104. As discussed in greater detail below, these magnets and Hall-effect switches are used to detect whether the flip cover 104 is in the portrait configuration, the landscape configuration, or the closed configuration.

FIGS. 3 through 5 illustrate an underside view of a circuit board 300 located inside the main body 102 in accordance with a preferred embodiment of the present invention. FIGS. 3 through 5 also illustrates the position of the flip cover 104 (shown by dashed lines) in relation to the circuit board 300. FIG. 3 illustrates the flip cover 104 opened in the portrait configuration. FIG. 4 illustrates the flip cover 104 opened in the landscape configuration. FIG. 5 illustrates the flip cover 104 in the closed configuration.

FIGS. 3 through 5 show the portrait magnet 302, landscape magnet 304, portrait Hall-effect switch 306, and landscape Hall-effect switch 308 in the preferred embodiment illustrated. In the preferred embodiment, also disposed on the circuit board 300 are two processors: a main processor such as an ARM controller, and a multimedia core processor such as a DSP processor (e.g., the TI HELEN processor available from Texas Instruments of Dallas, Tex.). The portrait magnet 302 and landscape magnet 304 are disposed within the flip cover 104, and the portrait Hall-effect switch 306 and landscape Hall-effect switch 308 are disposed on the circuit board 300. FIGS. 3 through 5 also illustrate the magnetic field 310 of the portrait magnet and the magnetic field 312 of the landscape magnet in the form of magnetic flux lines which radiate from the portrait magnet 302 and landscape magnet 304, respectively.

The use of Hall-effect switches for sensing magnet fields is well known. Briefly, a Hall-effect switch is in either an open or closed state depending on whether or not there is a magnetic field in the vicinity. When a Hall-effect switch is in contact with a magnetic field that is above a certain threshold level, the Hall-effect switch is “activated” (also referred to as “triggered”, “turned on”, or “closed”) and the Hall-effect switch outputs a first signal. When the Hall-effect switch is not in contact with a magnetic field above the threshold level, the Hall-effect switch is “inactivated” (also referred to as “turned off” or “open”), and a second signal is output from the Hall-effect effect switch. Thus, the output of a Hall-effect switch can be used to determine the presence or absence of a local magnet.

In preferred embodiments, the device 100 has at least three physical configurations, referred to as the portrait, landscape, and closed configurations. The device 100 is switched between these three configurations by repositioning the flip cover 104 to the portrait, landscape, or closed configuration. In the illustrated embodiment, these alternative positions of the flip cover 104 activate different modes of operation of the device 100 by triggering a different combination of Hall-effect switches (or not triggering any Hall-effect switches) in each physical configuration. A different combination of Hall-effect switches is triggered (or not triggered) in each configuration because the Hall-effect switches and magnets are disposed about the device 100 such that changing the position of the flip cover 104 in relation to the main body 102 (i.e., switching between different physical configurations) changes the distance between one or more Hall-effect switches and the corresponding magnets, so as to bring a different combination of Hall-effect switches into (or out of) contact with a magnetic field in each configuration.

In the preferred embodiment of the present invention illustrated in FIG. 3, when the flip cover 104 is opened in the portrait configuration, no magnetic fields from any of the magnets contact any of the corresponding Hall-effect switches. Thus, magnetic field 310 does not contact the corresponding portrait Hall-effect switch 306, and magnetic field 312 does not contact the corresponding landscape Hall-effect switch 308. As illustrated in FIG. 4, when the flip cover 104 is opened in the landscape configuration, only magnetic field 312 contacts the corresponding landscape Hall-effect switch 308; magnetic field 310 does not contact the corresponding portrait Hall-effect switch 306. As illustrated in FIG. 5, when the flip cover 104 is in the closed configuration, magnetic fields from both of the magnets contact both of the corresponding Hall-effect switches. Thus, magnetic field 310 contacts the corresponding portrait Hall-effect switch 306, and magnetic field 312 contacts the corresponding landscape Hall-effect switch 308.

Thus, the magnets and Hall-effect switches are disposed about the device 100 such that different combinations of Hall-effects switches are activated (or inactivated) depending on whether the flip cover 104 is positioned in the portrait, landscape, or closed configuration with respect to the main body 102. This enables the physical configuration of the device 100 to be detected, and this information regarding the physical configuration state enables the mode of operation of the device 100 to be adjusted “on the fly” (such as by the exemplary process described below with respect to FIG. 6). For example, adjusting the mode of operation of the device 100 can include any or all of the following: changing the operating mode of the inputs 106 (e.g., switching between numeric and QWERTY keypad layouts), changing the display 108 (e.g., switching between portrait and landscape display formats or views), changing the active software application (e.g., changing the operating system and/or switching between a phone application in the portrait mode, and a text (non-phone) application in the landscape mode), and changing drivers (e.g., changing keypad drivers in order to change the functional characters on the keypad).

By adjusting the mode of operation when the physical configuration is changed, the device 100 can provide the capabilities of multiple different types of portable electronic devices in a single unit. For example, in preferred embodiments, in the portrait configuration, the device 100 functions at least as a cellular phone (and, in certain embodiments, as a camera, etc.), whereas in the landscape configuration, the device 100 functions as a text-messaging pager, PDA, and/or handheld computer. In these preferred embodiments, when the flip cover 104 is in the closed configuration, the device 100 is put into standby mode or turned off to conserve battery power. Thus, in these embodiments, the device 100 has three distinct physical configurations, with each configuration having a distinct mode of operation.

Although the figures illustrate the magnets and Hall-effect switches disposed in various positions about the device 100 in accordance with a preferred embodiment of the present invention, each of these magnets and Hall-effect switches can generally be positioned in any desired location of the device 100 as long as the magnets and Hall-effect switches are in a proper position with respect to one another to carry out the intended function of sensing the present physical configuration of the device 100. Preferably, the magnets and Hall-effect switches are paired together, such that each magnet is paired with a corresponding Hall-effect switch and each Hall-effect switch is paired with a corresponding magnet.

Preferably, each pair (i.e., a Hall-effect switch in combination with a magnet) is positioned such that one member of the pair is positioned on a first body element (e.g., the main body 102) of the device 100 and the other member of the pair is positioned on a second body element (e.g., the flip cover 104) that is pivotally coupled to the first body element, with the relative positions of the first body element and second body element with respect to one another determining the physical configuration and corresponding mode of operation of the device 100 (and, consequently, the mode of operation of one or more of the inputs, displays, and/or active software applications). All that is required is that in each alternative physical configuration, a different combination of Hall-effect switches activated. Thus, a different combination of Hall-effect switches generate output signals in each physical configuration. Because the output signals from the Hall-effect switches differ between physical configurations, any change in the physical configuration of the device 100 can be detected by logic circuitry or a processor coupled to the switches.

For example, in the preferred embodiment, a first body element (the main body 102) incorporates two Hall-effect switches and the second body element (the flip cover 104) incorporates two magnets. The Hall-effect switches and magnets are positioned within the device 100 such that both Hall-effect switches are activated in the closed configuration, neither Hall-effect switch is activated in the portrait configuration, and a single Hall-effect switch is activated in the landscape configuration.

While in the preferred embodiment, as illustrated throughout the figures, the portrait magnet 302 and landscape magnet 304 are located in the flip cover 104, whereas the portrait Hall-effect switch 306 and landscape Hall-effect switch 308 are located in the main body 102, in an alternative embodiment the positions of these components can be reversed such that the portrait magnet 302 and landscape magnet 304 are located in the main body 102, whereas the portrait Hall-effect switch 306 and landscape Hall-effect switch 308 are located in the flip cover 104. In further embodiments, any combination thereof, such as positioning one or more of both a magnet and a Hall-effect switch in the main body 102, and one or more of both a magnet and a Hall-effect switch in the flip cover 104, can be implemented.

Additionally, although in the exemplary embodiment shown in the figures, the magnets and Hall-effect switches are positioned near a hinge or near the periphery of the device 100, the magnets and Hall-effect switches can generally be disposed in any position throughout the main body 102 or flip cover 104, such as closer to the center of the device 100, as long as the magnets and corresponding Hall-effect switches are in a proper position with respect to one another to carry out the intended function of detecting the present physical configuration of the device 100.

Furthermore, although in the exemplary embodiment shown in the figures, the Hall-effect switches are shown disposed on a single circuit board 300 within the main body 102, the Hall-effect switches could be disposed on multiple circuit boards, not disposed on any circuit boards (e.g., disposed on the outer body casing), or a combination thereof. Moreover, the Hall-effect switches could be disposed in any desired position on the circuit board 300 and are not limited to being disposed near the periphery of the circuit board 300, as shown in the exemplary embodiment. Furthermore, the Hall-effect switches could be disposed on either or both sides of the circuit board 300.

Moreover, although a single portrait magnet 302, a single landscape magnet 304, a single portrait Hall-effect switch 306, and a single landscape Hall-effect switch 308 are illustrated and described herein in accordance with a preferred embodiment of the present invention, the invention is not so limited, and any number of each of these magnets and Hall-effect switches can be implemented in a device. For example, additional Hall-effect switches and additional magnets may be desirable in further embodiments of the present invention in which the device has additional physical configurations (in addition to, for example, the portrait, landscape, and closed configurations).

Although the use of Hall-effect switches to detect magnetic fields is described herein as a preferred means of sensing the physical configuration of the device 100, the invention is not so limited, and other means for detecting the physical configuration of the device (e.g., the position of the flip cover 104 or other body element in relation to the main body 102 or other body element) can be implemented. Hall-effect switches are the preferred sensing mechanism because they are compact, inexpensive, easy to manufacture, have low power consumption, and are reliable (because sensing does not require mechanical contact between a Hall-effect switch and magnet, wear and malfunction due to mechanical contact is essentially eliminated).

However, any other sensing mechanism can be used, including, for example, mechanical switches or contacts, electrical switches, optical switches, pressure-sensing sensing switches, and/or other types of magnetic-based sensing mechanisms. Further, different sensing mechanisms can be used to detect different physical configurations. For example, in one embodiment a mechanical switch is used to detect when the device is closed, while Hall-effect switches are used to determine whether, when open, the device is in the portrait or landscape configuration. All that is required is some means for detecting the present physical configuration of the device. It should be noted that “physical configuration” refers to the present layout of the physical device (e.g., portrait, landscape, or closed), and not to the general orientation of the device (e.g., horizontal or vertical to the ground as determined by a gravity or acceleration sensor).

FIG. 6 is a flow chart of an exemplary process for changing the mode of operation based on the physical configuration of a multi-configuration device. When the physical configuration of the device is changed (e.g., between the portrait configuration and landscape configuration as described above), the state of one or more of the Hall-effect switches changes due to changes in magnetic field locations (step S10). The output signals of the Hall-effect switches are supplied to logic circuitry. When the state of one or more of the switches changes, the logic circuitry generates an interrupt that is supplied to one or more processors (or controllers) of the device (step S12). The interrupt alerts the processors of the new physical configuration and they react by changing the operating mode of the device. For example, changing the operating mode of the device 100 can include altering any or all of the inputs 106, the display 108, the active software applications, the operating system, the drivers, and so on.

In the exemplary process of FIG. 6, when a portrait interrupt is generated, the keypad is set to function as a numeric keypad (step S14). In preferred embodiments, the keypad is an adaptable keypad having keys that are each capable of displaying and functioning as multiple characters (e.g., the E-INK keypad available from the assignee of the present invention). Such adaptable keypads are described in greater detail in U.S. Patent Application Publication No. US 2003/0058223, which is hereby incorporated by reference. In response to the portrait interrupt, the processor sets a flag. This causes the adaptable keypad to display the standard characters of a numeric keypad with a portrait orientation as illustrated in FIG. 1, and the keypad driver to interpret key presses as the displayed characters.

Additionally, when a portrait interrupt is generated, the display is set to portrait view so that the orientation of the display matches the physical configuration of the device (step S16). In preferred embodiments, the display is a conventional LCD display that can be switched between a portrait view in which the displayed image is presented in a portrait format (i.e., the vertical dimension is greater than the horizontal dimension) and a landscape view in which the displayed image is presented in a landscape (or panoramic) format (i.e., the horizontal dimension is greater than the vertical dimension). In response to the portrait interrupt, the display driver formats or reformats the displayed image for the aspect ratio of the portrait view. This image is then displayed with the correct orientation so as to match the physical configuration of the device in portrait mode.

Further, when a portrait interrupt is generated, the active software application is changed to a phone application (step S18). In preferred embodiments, the phone application is any number of a phone dialer application, an address book application, and a camera application. In response to the portrait interrupt, the software that is currently active on the device is automatically switched so that the device begins functioning as a cellular phone. Thus, changing the physical configuration of the device to the portrait configuration generates a portrait interrupt that causes the keypad, display, and active software application to automatically switch so that the device functions as a standard cellular phone.

Similarly, when a landscape interrupt is generated, the keypad is set to function as a text or “QWERTY” keypad (step S20). In preferred embodiments, the processor sets a flag in response to the landscape interrupt. This causes the adaptable keypad to display the standard QWERTY characters of a text keypad with a landscape orientation as illustrated in FIG. 2, and the keypad driver to interpret key presses as the displayed characters.

Additionally, when a landscape interrupt is generated, the display is set to landscape view so that the orientation of the display matches the physical configuration of the device (step S22). In preferred embodiments, the display driver formats or reformats the displayed image for the aspect ratio of the landscape view in response to the landscape interrupt. This image is then displayed with the correct orientation so as to match the physical configuration of the device in landscape mode.

Further, when a landscape interrupt is generated, the active software application is changed to a text application (step S24). In preferred embodiments, the text application is any number of a text-messaging application, a notepad application, a spreadsheet application, an organizer application, a media player application (such as an MP3 or video player), and a game application. In response to the landscape interrupt, the software that is currently active on the device is automatically switched so that the device begins functioning as a text messaging pager, a PDA, a handheld computer, a media player, or the like. Thus, changing the physical configuration of the device to the landscape configuration generates a landscape interrupt that causes the keypad, display, and active software application to automatically switch so that the device functions as a text (non-phone) device such as text messaging pager or PDA.

When a closed interrupt is generated, the device enters a standby mode or is turned off in order to conserve battery power (step S30).

Thus, a change in the physical configuration of the device causes a change in the activation states of the sensing switches. This, in turn, causes the logic circuitry to generate an interrupt that changes the operating mode of the device.

In preferred embodiments of the present invention, this mode change is done “on the fly”. In particular, the operation of the inputs, display, and software is changed automatically without the need to load or reload the operating system, drivers, or software applications. Furthermore, the processors of the device do not have to continuously monitor sensing switches for the present physical configuration state of the device. Rather, mode changes are interrupt driven with any change in the physical configuration of the device causing an interrupt to be supplied to the processors. However, in further embodiments, the operating system and/or drivers are also changed in response to a change in the physical configuration of the device. Similarly, in some embodiments, the applications are loaded as-needed, instead of all being preloaded and just switching the presently active application.

While the keypad is the input device that is changed in the exemplary embodiment of FIG. 6, in further embodiments other or different inputs can be changed. For example, in various embodiments, the inputs include a keypad (or keyboard), a mouse, a pen, a touch screen, a touchpad, a trackball, a joystick, a fingertip joystick, directional keys, selector buttons, toggle switches, rotating dials, video game controllers, and/or any other type of input device or peripheral. In such embodiments, the mode of operation of any number of these inputs can be changed based on the physical configuration of the device in steps S14 and S20. For example, besides changing the characters of the keys of the keypad, the orientation of an input device such as a fixed trackball can be changed. Similarly, changing the mode of operation of the inputs also encompasses changing which input device or devices are used for input. For example, in one physical configuration the keypad could be the input device, whereas in another physical configuration, a pen and touch-screen display could be the input device. Preferably, the processor uses one or more flags to cause the input devices to operate in either portrait or landscape configuration.

Further, in the exemplary embodiment of FIG. 6, the mode of operation of the inputs, display, and active software application are all changed in response to a change in the physical configuration of the device (e.g., a repositioning of the flip cover). However, in further embodiments, different combinations of the inputs, display, and active software application change their mode of operation in response to a change in the physical configuration of the device. For example, in one embodiment, only the inputs (e.g., characters of the keypad) and display in response to a change in the physical configuration of the device. In another embodiment, only the display and the active software application changes in response to a change in the physical configuration of the device. In further embodiments, features other than the inputs, display, and active software application are also be changed.

Accordingly, preferred embodiments of the present invention offer significant advantages. The present invention enables the functionality of multiple independent portable electronic devices to be integrated into a single unit. This eliminates the need for a consumer to purchase, maintain, and carry multiple devices (as well as associated peripherals and batteries). Thus, the multi-configuration portable electronic device of the present invention is cost-effective. Additionally, carrying a single, multi-functional device is significantly more convenient and less cumbersome than carrying multiple devices with different functions. Furthermore, the likelihood of losing or damaging a single portable electronic device is less than when the consumer has to keep track of multiple devices.

The present invention can be realized in hardware (such as by using logic circuits, registers, and state machines), software, or a combination of hardware and software (e.g., on a wireless device). Any kind of information processing system-or other apparatus adapted for carrying out the methods described herein-is suited. A typical combination of hardware and software could be a general-purpose processor with a computer program that, when being loaded and executed, controls the processor such that it carries out the methods described herein.

An embodiment of the present invention can also be embedded in a computer program product that includes all the features enabling the implementation of the methods described herein, and which, when loaded in a device, is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A device may include, inter alia, one or more processors and at least a machine-readable or computer-readable medium. The terms “computer program medium,” “computer-usable medium,” “machine-readable medium” and “computer-readable medium” are used to generally refer to media such as main memory and secondary memory, a removable storage drive, a hard disk installed in hard disk drive, and signals. These computer program products are means for providing software to the device and its processor or processors. The computer-readable medium allows the device to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. Additionally, a machine-readable or computer-readable medium may include, for example, volatile storage such as RAM, buffers, cache memory, and network circuits. Furthermore, the machine-readable or computer-readable medium may include information in a transitory state medium such as a network link and/or a network interface, including a wired network or a wireless network, that allow a computer system to read such computer-readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A multi-configuration portable electronic device comprising:
at least one processor;
a first body element including at least one input device; and
a second body element including a display, the second body element being pivotally coupled to the first body element such that the portable electronic device can be positioned into a plurality of physical configurations,
wherein at least two of a mode of operation of the input device, a mode of operation of the display, and an active software application being executed by the processor are changed in response to a change in the physical configuration of the portable electronic device.

2. The portable electronic device of claim 1, wherein in response to a change in the physical configuration of the portable electronic device, the mode of operation of the display changes between portrait view and landscape view.

3. The portable electronic device of claim 2,
wherein the at least one input device includes an adaptable keypad, and
in response to a change in the physical configuration of the portable electronic device, the mode of operation of the adaptable keypad changes between numeric layout and text layout.

4. The portable electronic device of claim 3, in response to a change in the physical configuration of the portable electronic device, the active software application being executed by the processor is changed between a phone application and a text application.

5. The portable electronic device of claim 2, in response to a change in the physical configuration of the portable electronic device, the active software application being executed by the processor is changed between a phone application and a text application.

6. The portable electronic device of claim 1,
wherein the at least one input device includes an adaptable keypad, and
in response to a change in the physical configuration of the portable electronic device, the mode of operation of the adaptable keypad changes between numeric layout and text layout.

7. The portable electronic device of claim 6, in response to a change in the physical configuration of the portable electronic device, the active software application being executed by the processor is changed between a phone application and a text application.

8. The portable electronic device of claim 1,
wherein the at least one input device includes a directional input device selected from the group consisting of a mouse, a touchpad, a trackball, and a rotating dial, and
in response to a change in the physical configuration of the portable electronic device, the mode of operation of the directional input device is changed between a portrait orientation and a landscape orientation.

9. The portable electronic device of claim 1, in response to a change in the physical configuration of the portable electronic device, the active software application being executed by the processor is changed between a phone application and a text application.

10. The portable electronic device of claim 1, wherein in response to a change in the physical configuration of the portable electronic device the active software application is changed on the fly without a need to load or reload an operating system, drivers, or software applications.

11. The portable electronic device of claim 1, wherein the plurality of physical configurations of the portable electronic device include a portrait configuration and a landscape configuration.

12. The portable electronic device of claim 11,
wherein in response to a change in the physical configuration of the portable electronic device from the portrait configuration to the landscape configuration, the active software application being executed by the processor is changed between a phone application and a text application,
the phone applications includes at least one of a phone dialer and an address book, and
the text application includes at least one of text messaging, a notepad, a spreadsheet, an organizer, and a media player.

13. The portable electronic device of claim 11,
wherein in the portrait configuration the portable electronic device functions as a wireless phone, and in the landscape configuration the portable electronic device functions as one or more of a text messaging pager, a PDA, a handheld computer, an electronic organizer, and a media player.

14. The portable electronic device of claim 1, further comprising sensing switches for detecting the physical configuration of the portable electronic device, the sensing switches being integrated into at least one of the first and send body elements.

15. The portable electronic device of claim 14, further comprising logic circuitry coupled between the sensing switches and the processor, the logic circuitry supplying an interrupt to the processor in response to a change in the physical configuration of the portable electronic device.

16. A method of operating a portable electronic device having a plurality of physical configurations, said method comprising the steps of:
generating an interrupt in response to a change in the physical configuration of the device; and
in response to the interrupt, changing at least two of a mode of operation of an input of the device, a mode of operation of a display of the device, and an active software application being executed on the device.

17. The method of claim 16, wherein the changing step includes the sub-steps of:
changing the mode of operation of the display between a portrait view and a landscape view; and
changing the mode of operation of the input by changing a keypad between a numeric layout and a text layout.

18. The method of claim 16, wherein the changing step includes the sub-steps of:
changing the mode of operation of the display between a portrait view and a landscape view; and
changing the active software application between a phone application that causes the device to function as a wireless phone and a text application that causes the device to functions as one or more of a text messaging pager, a PDA, a handheld computer, an electronic organizer, and a media player.

19. The method of claim 16, wherein the changing step includes the sub-steps of:
changing the mode of operation of the input by changing a keypad between a numeric layout and a text layout; and
changing the active software application between a phone application that causes the device to function as a wireless phone and a text application that causes the device to functions as one or more of a text messaging pager, a PDA, a handheld computer, an electronic organizer, and a media player.
